(19) United States
(12) Patent Application Publication
(10) Pub. No.: US 2007/0058944 A1
(43) Pub. Date: Mar. 15, 2007

(54) Bookmark audiovisual

(76) Inventor: Laurence Garfield Millar, Surrey (GB)

Correspondence Address: MR LAURENCE MILLAR, 3 ORCHARD ROAD, CHESSINGTON, SURREY, KT9 1AJ, GB

(21) Appl. No.: 11/474,526

(22) Filed: Jun. 27, 2006

(30) Foreign Application Priority Data
Dec. 22, 2005 (GB) GB0526095.5
Nov. 23, 2005 (GB) GB0523875.3
Nov. 23, 2005 (GB) GB0523876.1
Sep. 9, 2005 (GB) GB0518535.0
Jan. 20, 2006 (GB) GB0601148.0

(51) Int. Cl. H04N 7/00

(52) U.S. Cl. 386/96

(57) ABSTRACT

A bookmark 1 includes a light sensor 2 that is positioned on the bookmark 1 to be out of the light when placed inside of a book. Allowing light onto the light sensor 2 through the opening of the book activates a computer graphical display screen 3 on the bookmark 1 to display a written message or image and an audio speaker 4 to relay an audio message or song. The bookmark 1 can be made to only include only the light sensor 2 and computer graphical display screen 3(see FIG. 6) or the light sensor 2 and audio speaker 4(see FIG. 7) or a combination of the light sensor 2, computer graphical display screen 3 and audio speaker 4.

### CROSS-REFERENCE TO RELATED APPLICATIONS

The related patent application GB0601148.0. was filed in the United Kingdom on 20-Jan-2006 and claimed priority over prior patent applications GB0526095.5 filed on 22-Dec-2005 patent application GB0523875.3 filed on 23-Nov-2005 patent application GB0523876.1 filed on 23-Nov-2005 and patent application GB0518535.0 filed on 09-Sep-2005 all patent applications are filed in the Untied Kingdom.

### STATEMENT REGARDING FEDERALLY SPONSORED RESEACH OR DEVELOPMENT

Not applicable

### REFERENCE TO SEQUENCE LISTINGS, A TABLE, OR A COMPUTER PROGRAM LISTING COMPACT DISC APPENDIX

Not applicable

### BACKGROUND OF THE INVENTION

My invention relates to a bookmark of the type which is used for marking a page in a book.

Bookmarks are well-known but apart from marking a page in a book offer no other function.

The bookmarks unique function is that it is audiovisual and can display a written message(s) or image(s) on a computer graphical display screen on the front of the bookmark and an audio message(s) or song(s) through an audio speaker which can be used as a learning aid.

### BRIEF SUMMARY OF THE INVENTION

Accordingly, this invention provides a bookmark with a light sensor that when triggered activates a computer graphical display screen and an audio speaker on the bookmark. The computer graphical display screen displays a programmed written message or image while the audio speaker accompanies with a programmed audio message or song. The light sensor is positioned on the bookmark where it would be out of the light when placed inside a book. Allowing light onto the bookmark through the opening of the book triggers the light sensor to activate the computer graphical display screen on the and an audio speaker on the bookmark to relay an audio message(s) or song(s).

### BRIEF DESCRIPTION OF THE SEVERAL VIEWS OF THE DRAWING

FIG. 1 shows a view of the front of the bookmark at an angle;

FIG. 2 shows a view of the front of the bookmark;

FIG. 3 shows a view of the back of the bookmark;

FIG. 4 shows the bookmark from a top view;

FIG. 5 shows the bookmark from a side view.

FIG. 6 shows the bookmark with only the computer graphical display screen and light sensor.

FIG. 7 shows the bookmark with only the audio speaker and light sensor.

### DETAILED DESCRIPTION OF THE INVENTION

Preferably the bookmark will include a light sensor a computer graphical display screen and audio speaker, but it may instead be made to include a light sensor and computer graphical display screen only or alight sensor and audio speaker only and would be made from card, plastic or metal.

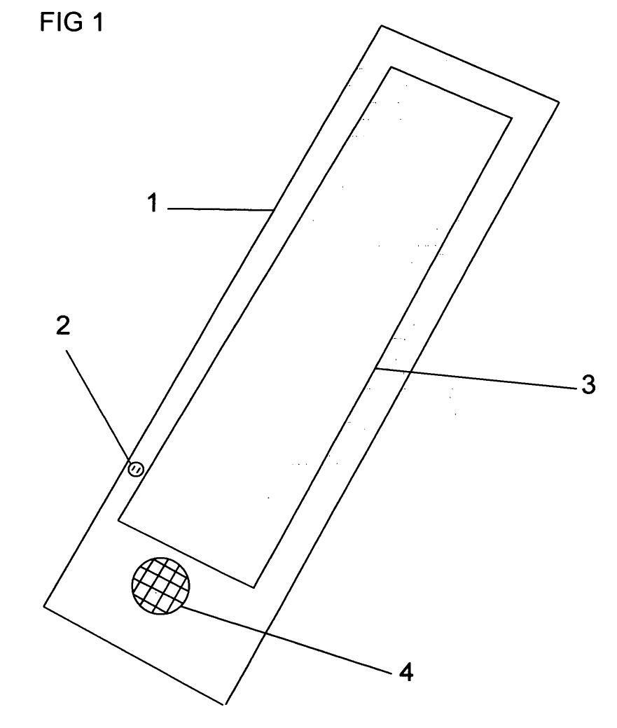

A preferred embodiment of the invention will now be described with reference to the accompanying drawings as shown in FIG. 1 the bookmark 1 has a light senor 2 a computer graphical display screen 3 and audio speaker 4.

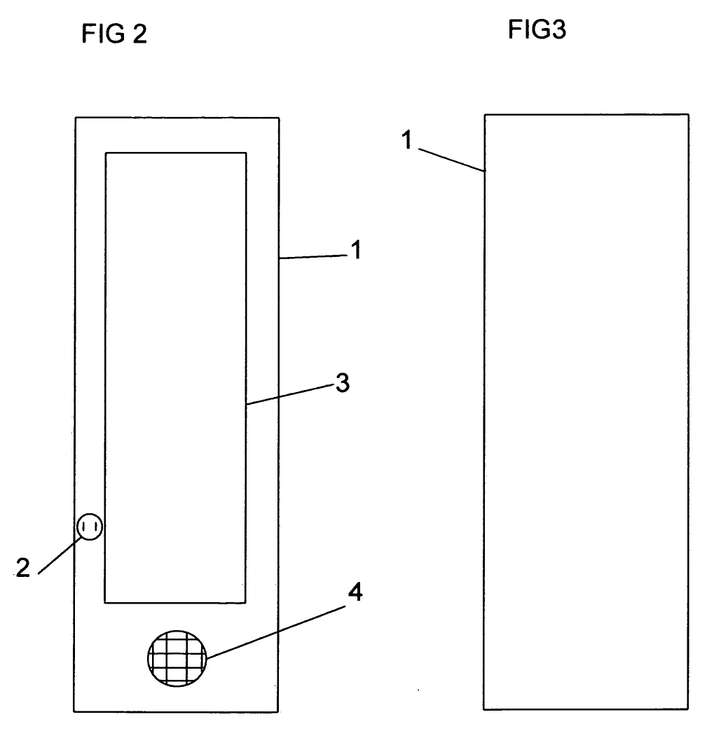

As shown in FIG. 2 a view of the front of bookmark 1 showing the light sensor 2 the computer graphical display screen 3 and audio speaker 4. The light sensor 2 is positioned on the bookmark 1 where it would be out of the light when placed inside of a book.

As shown in FIG. 3 the back view of the bookmark 1

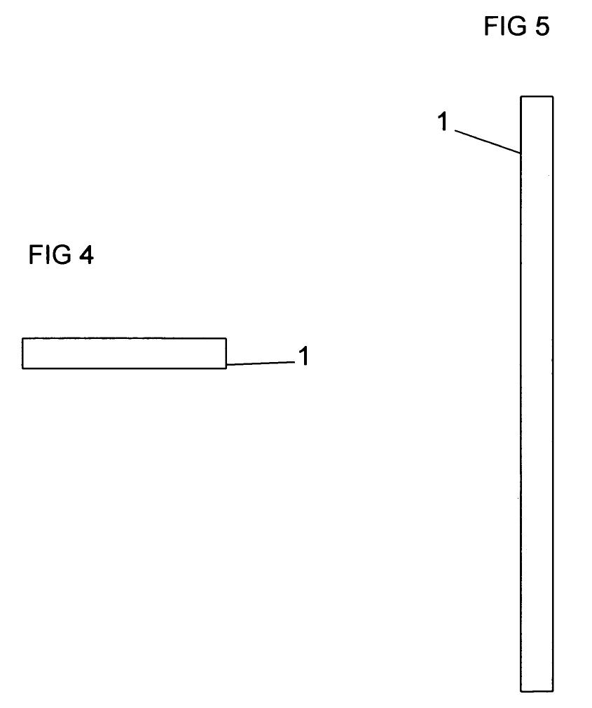

As shown in FIG. 4 a top profile view of the bookmarks.

As shown in FIG. 5 a side profile view of the bookmark 1.

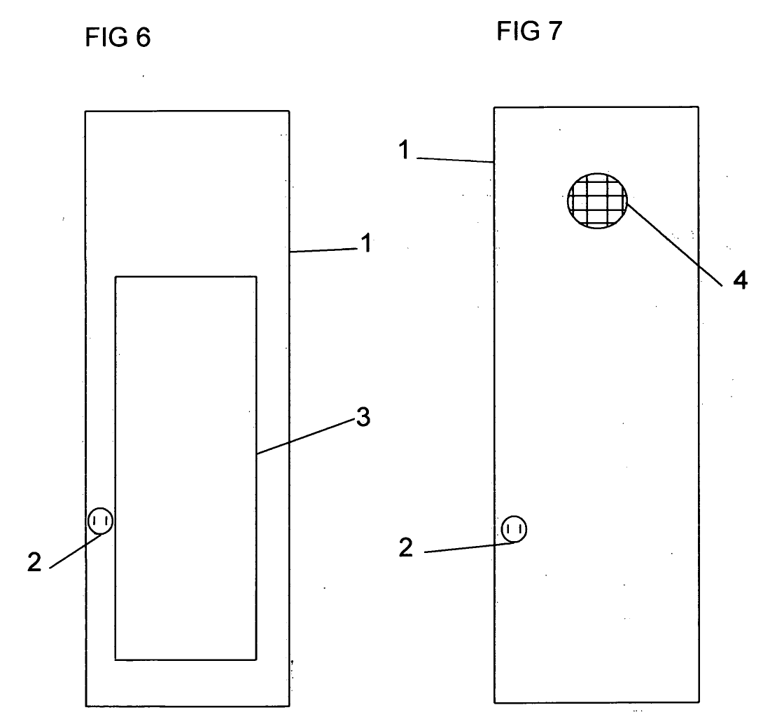

As shown in FIG. 6 the bookmark 1 containing the light senor 2 and computer graphical display screen 3 without the audio speaker 4.

As shown in FIG. 7 the bookmark 1 containing the light sensor 2 and audio speaker 4 without the computer graphical digital display screen 3.

The bookmark 1 contains a light sensor 2 a computer graphical display screen 3 and an audio speaker 4 as shown in FIG. 1. The light sensor 2 is positioned on the bookmark 1 where it would be out of the light when placed inside a book. The opening of the book would allow light onto the light sensor 2 and would trigger the light sensor 2 to activate the computer graphical display screen 3 to display a written message(s) or image(s) and the audio speaker 4 to relay an audio message(s) or song(s).

1. I claim a bookmark including a light sensor that is positioned on the bookmark where it would be out of the light when placed inside a book activates when light is allowed onto the bookmark through the opening of the book triggering the light sensor on the bookmark to activate a computer graphical display screen to display a written message or image and an audio speaker on the bookmark to relay an audio message or song.

2. The bookmark as claimed in claim 1 can display more than one written message or image on a computer graphical display screen and relay more than one audio message or song through an audio speaker.

3. The bookmark as claimed in claimed 1 and 2 computer graphical display screens written message or image accompanies the audio speaker's message or song.

4. The bookmark as claimed in claim 1, 2 and 3 can be used as a learning aid.

5. The bookmark as claimed in claim 1, 2, 3 and 4 may be made to include only a computer graphical display screen and light sensor or an audio speaker and light sensor or the combination of the computer graphical display screen, audio speaker and light sensor.
